(19) United States
(12) Patent Application Publication
(10) Pub. No.: US 2008/0305731 A1
(43) Pub. Date: Dec. 11, 2008

(54) POSITIONABLE BACK DRAFT ASSEMBLY

(76) Inventors: James K. Reid, Gahanna, OH (US); John Reid, Royal Oak, MI (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/135,469

(22) Filed: Jun. 9, 2008

Related U.S. Application Data
(60) Provisional application No. 60/942,870, filed on Jun. 8, 2007.

(51) Int. Cl. B08B 15/02; A62C 3/00; B01D 45/00

(52) U.S. Cl. 454/65; 454/63; 169/54; 55/437

(57) ABSTRACT

A filter housing, a duct arm and a hood which is positioned near the fume source as the duct arm extends between the hood and the filter housing for conveying the fumes from the hood to the filter housing. The filter housing includes a motor for generating suction at the hood inlet and for propelling the fumes out of the filter housing through a housing outlet. The motor has a power ranging from 7.5 to 10.0 horsepower for moving air through the assembly at speeds exceeding 6000 feet per minute (fpm) and at flow rates exceeding 2100 cubic feet per minute (cfm). The hood has a depth of 12 inches and the hood inlet has a width of 36.44 inches and a height of 12.51 inches.

### BACKGROUND OF THE INVENTION

This invention claims priority to U.S. Provisional Application Ser. No. 60/942,870, filed Jun. 8, 2007.

1. Field of the Invention

The invention relates to air filtration systems and more particularly to positionable back draft assemblies that are used in industrial environments to filter and re-circulate the fumes from a fume source.

2. Description of the Prior Art

Many factories use machines or equipment, in welding for example, which create unhealthy fumes that must be filtered. Back draft assemblies, and positionable fume arms have been used near the source of the fumes, e.g. the work-piece being welded.

Positionable fume arms often include a small hood and a fume arm. The hood is positioned near the fume source and the fume arm transfers the fumes to the filter housing where they are filtered. A low horsepower motor is used to drive a fan in these positionable arm systems.

One example of a fume arm and a hood is disclosed in U.S. Pat. No. 5,738,148, issued to Coral et al. on Apr. 14, 1998 (hereinafter referred to as Coral '148). Coral '148 discloses a fume arm having a first end in fluid communication with the housing inlet of the filter housing and extending to a distal end for conveying fumes to the housing inlet. Coral '148 also includes a hood having a hood outlet in fluid communication with the distal end of the fume arm. The hood presents a face defining a hood inlet for receiving the fumes from a fume source, e.g. a work-piece being welded.

The hood of a fume must be placed no farther than eighteen inches from the fume source in order to be effective. In certain applications, for example when a large work-piece is being welded, the hood must be consistently moved along the work-piece to maintain adequate filtration of the fumes. Welders often neglect to move the hood because of the effort required to do so and because it breaks their concentration on the welding operation. Neglecting to consistently move the hood to keep it within the eighteen inch operating range thereby compromises the quality of air in the work environment.

One example of a back draft housing is manufactured by the assignee of the subject invention. The back draft housing includes a housing inlet for receiving the fumes and a housing outlet for dispensing the fumes. A motor and a fan operatively connected to the motor generates suction at the housing inlet and propels the fumes out of the housing through the housing outlet. A filter is disposed in the housing for filtering particulates from the fumes.

Back draft housings are very effective when used in, for example, welding cells. The back draft housing is usually floor mounted and is very powerful so that it can pull fumes from the welding cell.

The problem with back draft housings is that they cannot be effectively used on long welds. The distance between the back draft housing and the point of the weld has to be in the unit's range, or it will be ineffective.

What is needed is a positionable back draft assembly. To applicant's knowledge there are no positionable back draft assemblies.

### SUMMARY OF THE INVENTION

The invention provides for a positionable back draft assembly and includes a motor having a power ranging from 7.5 to 10.0 horsepower. The motor and fan are capable of moving air through the hood, duct arm and the filter housing at speeds exceeding 6000 feet per minute (fpm) and at flow rates exceeding 2100 cubic feet per minute (cfm). Such a high flow rate allows the back draft hood to be positioned over thirty-six inches (3 feet) from the fume source and still effectively filter the fumes. This substantially reduces the time and effort required to effectively filter the fumes from the fume source and reduces the chance of error on the part of the welder.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a side view of the subject invention and showing a cross-sectional view of the back draft housing; and

FIG. 2 is a perspective view of the hood.

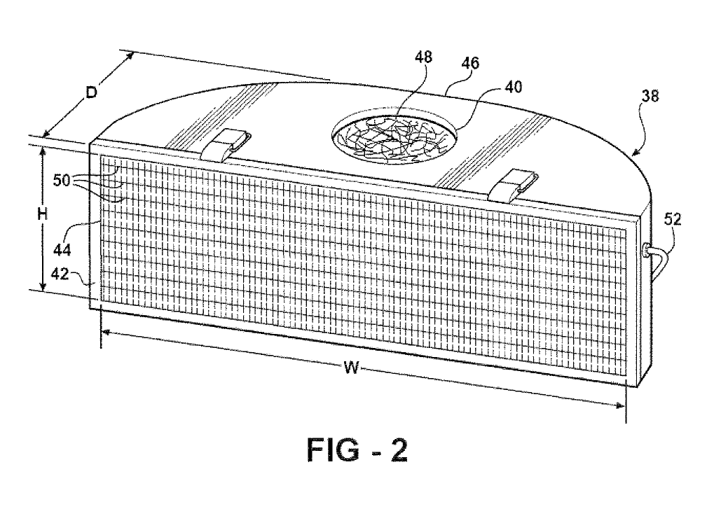

### DETAILED DESCRIPTION OF THE EXEMPLARY EMBODIMENT

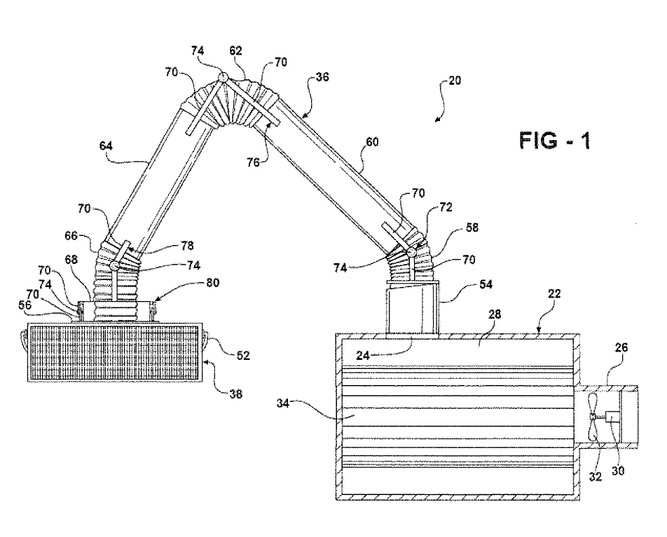

Referring to the Figures, wherein like numerals indicate corresponding parts throughout the several views, a positionable back draft assembly 20 is generally shown in FIG. 1.

The assembly 20 includes a filter housing 22, generally indicated, for filtering fumes and defining a housing inlet 24 for receiving the fumes and a housing outlet 26 for dispensing the fumes. An electric motor 30 is disposed in the filter housing 22. A fan 32 is operatively connected to the motor 30 for generating suction at the housing inlet 24 and for propelling the fumes out of the housing through the housing outlet 26. At least one filter 34 is disposed in the channel 28 for removing particulates from the fumes. One example of the filter housing 22 is the Robovent®, which is manufactured by Great Lakes Air Systems.

The assembly 20 further includes a duct arm 36, generally indicated, having a first end in fluid communication with the housing inlet 24 of the filter housing 22 and extending outwardly to a distal end for conveying fumes to the housing inlet 24. In the exemplary embodiment, the duct arm 36 is ten feet in length. However, the duct arm 36 may be of any length capable of reaching a fume source from the filter housing 22.

A hood 38, generally indicated, is disposed at the distal end of the duct arm 36 and has a hood outlet 40 in fluid communication with the distal end of the duct arm 36. The hood 38 presents a face 42 defining a hood inlet 44 for receiving the fumes from the fume source. In the exemplary embodiment, the hood 38 has a depth D and the hood inlet 44 has a cross-section presenting a rectangular shape having a width W and a height H. In the preferred embodiment, the width W of the hood inlet 44 is 36.44 inches, the height H of the hood inlet 44 is 12.44 inches, and the depth D of the hood 38 is 12 inches. The hood 38 has a semi-circular back 46 arcing from one side of the face 42 to the other for streamlining the flow of the fumes through the hood 38. The hood inlet 44 may have any cross-section for receiving the fumes from the fume source, e.g. circular, hexagonal, etc. Additionally, at least one filter 34 may be disposed in the hood 38. In the exemplary embodiment, a spark arrester 48, as is well known to those of ordinary skill in the art, including a wire mesh is disposed in the hood 38 for arresting sparks and other combustible materials, and a plurality of louvers 50 extend across and between opposite sides of the hood inlet 44 for dispersing the fumes entering the hood 38 from the fume source and for filtering out large materials from the fumes. A handle 52 is disposed on the hood 38 for manually moving the hood 38 and duct arm 36 relative to the filter housing 22.

The assembly 20 further includes a first swivel 54 interconnecting the housing inlet 24 of the filter housing 22 and the first end of the duct arm 36 for allowing rotation of the duct arm 36 relative to the filter housing 22. A second swivel 56 interconnects the hood outlet 40 of the hood 38 and the distal end of the duct arm 36 for allowing rotation of the hood 38 relative to the duct arm 36.

In the exemplary embodiment, the duct arm 36 serially includes a first flexible section 58 and a first rigid tube 60 and a second flexible section 62 and a second rigid tube 64 and a third flexible section 66. The first flexible section 58 extends from the first swivel 54, and the third flexible section 66 extends to the second swivel 56. Each of the flexible sections 58, 62, 66 is defined by a bellows tube, and a positioning ring 68 is disposed about the third flexible section 66.

The duct arm 36 of the exemplary embodiment also includes control arms 70 for controlling the movement of the duct arm 36 relative to the filter housing 22. A first pair of control arms 72, generally indicated, interconnects the first swivel 54 and the first rigid tube 60. The first pair of control arms 72 are pivotally connected together at a pivot 74 and include a first control mechanism for controlling pivotal movement of the control arms 70 relative to one another for moving the first rigid tube 60 relative to the first swivel 54. A second pair of control arms 76 interconnects the first rigid tube 60 and the second rigid tube 64. The second pair of control arms 76 are pivotally connected together at a pivot 74 and include a second control mechanism for controlling pivotal movement of the control arms 70 relative to one another for moving the second rigid tube 64 relative to the first rigid tube 60. A third pair of control arms 78 interconnects the second rigid tube 64 and the positioning ring 68. The third pair of control arms 78 are pivotally connected together at a pivot 74 and include a third control mechanism for controlling pivotal movement of the control arms 70 relative to one another for moving the positioning ring 68 relative to the second rigid tube 64. Finally, a fourth pair of control arms 80 interconnects the positioning ring 68 and the hood 38. The fourth pair of control arms 80 are pivotally connected together at a pivot 74 and include a fourth control mechanism for controlling pivotal movement of the control arms 70 relative to one another for moving the hood 38 relative to the positioning ring 68.

The duct arm 36 and the hood 38 are often very heavy and difficult for a user to manually move. To assist the user, the control mechanisms may include springs or actuators to bias the control arms 70 and help the user move the hood 38 relative to the filter housing 22 more easily. Additionally, the control mechanisms support the duct arm 36 and the hood 38 and hold them in place when the user releases the hood 38. To support the duct arm 36 and hood 38, the control mechanisms may include friction disks or dampers to hold the duct arm 36 and hood 38 in a desired position for the user.

The electric motor 30 of the filter housing 22 has a power ranging from 7.5 to 10.0 horsepower to move air through the hood 38, duct arm 36 and the filter housing 22 at speeds exceeding 6000 feet per minute (fpm) and for generating air flow rates in excess of 2100 cubic feet per minute (cfm). Such a large air flow rate allows the back draft hood 38 to be positioned over 36 inches (3 feet) from the fume source and still effectively capture and filter 34 the fumes.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A positionable back draft assembly including:
a filter housing for filtering fumes;
said filter housing defining a housing inlet for receiving the fumes and a housing outlet for dispensing the fumes;
a motor;
a fan disposed in said filter housing and operatively connected to said motor for generating suction at said housing inlet and for propelling the fumes out of said back draft housing through said housing outlet;
a duct arm having a first end in fluid communication with said housing inlet of said back draft housing and extending to a distal end for conveying fumes to said housing inlet;
a filter disposed in at least one of said back draft housing and said duct arm for removing particulates from the fumes;
a hood having a hood outlet in fluid communication with said distal end of said duct arm and presenting a face defining a hood inlet for receiving the fumes from a fume source; and
said motor having a power ranging from 7.5 to 10.0 horsepower.

2. The assembly as set forth in claim 1 wherein said hood inlet has a cross-section presenting a rectangular shape having a width being 36.44 inches and a height being 12.51 inches.

3. The assembly as set forth in claim 1 wherein said hood has a depth being 12 inches.

4. The assembly as set forth in claim 1 wherein said hood has a semi-circular back arcing from one side of said face to the other for streamlining the flow of the fumes through the hood.

5. The assembly as set forth in claim 1 wherein said duct arm includes at least one flexible section and at least one rigid tube.

6. The assembly as set forth in claim 1 wherein each of said at least one flexible sections is defined by a bellows tube.

7. The assembly as set forth in claim 1 further comprising a first swivel interconnecting said housing inlet of said back draft housing and said first end of said duct arm for allowing rotation of said duct arm relative to said back draft housing.

8. The assembly as set forth in claim 7 further comprising a first pair of control arms interconnecting said first swivel and said duct arm.

9. The assembly as set forth in claim 8 wherein said first pair of control arms are pivotally connected together at a pivot and includes a first control mechanism for controlling pivotal movement of said control arms relative to one another for moving said duct arm relative to said first swivel.

10. The assembly as set forth in claim 7 further comprising a second swivel interconnecting said hood outlet of said hood and said distal end of said duct arm for allowing rotation of said hood relative to said duct arm.

11. The assembly as set forth in claim 10 wherein said duct arm includes at least one flexible section and at least one rigid tube.

12. The assembly as set forth in claim 11 wherein said first arm serially includes a first flexible section and a first rigid tube and a second flexible section and a second rigid tube and a third flexible section.

13. The assembly as set forth in claim 12 wherein said first flexible section extends from said first swivel.

14. The assembly as set forth in claim 12 wherein said third flexible section extends to said second swivel.

15. The assembly as set forth in claim 12 further comprising a second pair of control arms interconnecting said first rigid tube and said second rigid tube.

16. The assembly as set forth in claim 15 wherein said second pair of control arms are pivotally connected together at a pivot and includes a second control mechanism for controlling pivotal movement of said control arms relative to one another for moving said second rigid tube relative to said first rigid tube.

17. The assembly as set forth in claim 12 farther including a positioning ring disposed about said third flexible section.

18. The assembly as set forth in claim 17 further including a third pair of control arms interconnecting said second rigid tube and said positioning ling.

19. The assembly as set forth in claim 18 wherein said third pair of control arms are pivotally connected together at a pivot and include a third control mechanism for controlling pivotal movement of said control arms relative to one another for moving said positioning ring relative to said second rigid tube.

20. The assembly as set forth in claim 17 further including a fourth pair of control arms interconnecting said positioning ring and said hood.

21. The assembly as set forth in claim 20 wherein said fourth pair of control arms are pivotally connected together at a pivot and include a fourth control mechanism for controlling pivotal movement of said control arms relative to one another for moving said hood relative to said positioning ring.

22. The assembly as set forth in claim 1 further including a spark arrester disposed in said hood for arresting sparks and other combustible materials.

23. The assembly as set forth in claim 22 wherein said spark arrester is a wire mesh.

24. The assembly as set forth in claim 1 further including a plurality of louvers extending across said hood inlet for dispersing the fumes entering the hood from the fume source and for filtering out large materials from the fumes.

25. The assembly as set forth in claim 1 further including a handle disposed on said hood for manually moving said hood and duct arm relative to said back draft housing.

26. The assembly as set forth in claim 1 wherein said motor is an electric motor and is disposed on said filter housing.

27. A positionable back draft assembly including:
a filter housing for filtering fumes;
said filter housing defining a housing inlet for receiving the fumes and a housing outlet for dispensing the fumes;
a motor being electric disposed on said filter housing;
a fan disposed in said filter housings and operatively connected to said motor for generating suction at said housing inlet and for propelling the fumes out of said filter housing through said housing outlet;
at least one filter disposed in said filter housing for removing particulates from the fumes;
a duct arm having a first end in fluid communication with said housing inlet of said filter housing and extending outwardly to a distal end for conveying fumes to said housing inlet;
a hood having a hood outlet in fluid communication with said distal end of said duct arm and presenting a face defining a hood inlet for receiving the fumes from a fume source;
said hood having a semi-circular back arcing from one side of said face to the other for streamlining the flow of the fumes through the hood;
said hood having a depth and said hood inlet having a cross-section presenting a rectangular shape having a width and a height;
a first swivel interconnecting said housing inlet of said filter housing and said first end of said duct arm for allowing rotation of said duct arm relative to said filter housing;
a second swivel interconnecting said hood outlet of said hood and said distal end of said duct arm for allowing rotation of said hood relative to said duct arm;
said duct arm serially including a first flexible section and a first rigid tube and a second flexible section and a second rigid tube and a third flexible section;
each of said flexible sections defined by a bellows tube;
said first flexible section extending from said first swivel;
said third flexible section extending to said second swivel;
a positioning ring disposed about said third flexible section;
a first pair of control arms interconnecting said first swivel and said first rigid tube and being pivotally connected together at a pivot and including a first control mechanism for controlling pivotal movement of said control arms relative to one another for moving said first rigid tube relative to said first swivel;
a second pair of control arms interconnecting said first rigid tube and said second rigid tube and being pivotally connected together at a pivot and including a second control mechanism for controlling pivotal movement of said control arms relative to one another for moving said second rigid tube relative to said first rigid tube;
a third pair of control arms interconnecting said second rigid tube and said positioning ring and being pivotally connected together at a pivot and including a third control mechanism for controlling pivotal movement of said control arms relative to one another for moving said positioning ring relative to said second rigid tube;
a fourth pair of control arms interconnecting said positioning ring and said hood and being pivotally connected together at a pivot and including a fourth control mechanism for controlling pivotal movement of said control arms relative to one another for moving said hood relative to said positioning ring;
a spark arrester including a wire mesh and disposed in said hood for arresting sparks and other combustible materials;
a plurality of louvers extending across and between opposite sides of said hood inlet for dispersing the fumes entering the hood from the fume source and for filtering out large materials from the fumes;
a handle disposed on said hood for manually moving said hood and duct arm relative to said back draft housing; and
said electric motor having a power ranging from 7.5 to 10.0 horsepower;
said width of said hood being 36.44 inches;
said height of said hood being 12.51 inches; and
said depth of said hood being 12 inches.
